(19) United States
(12) Patent Application Publication
(10) Pub. No.: US 2023/0412637 A1
(43) Pub. Date: Dec. 21, 2023

(54) HARDWARE DETECTION AND PREVENTION OF CRYPTOJACKING

(71) Applicant: INTERNATIONAL BUSINESS MACHINES CORPORATION, ARMONK, NY (US)

(72) Inventors: MICHAEL Peter LYONS, Arlington, MA (US); Andrew C. M. Hicks, Highland, NY (US); Miles C. Pedrone, Wappingers Falls, NY (US)

(21) Appl. No.: 17/806,983

(22) Filed: Jun. 15, 2022

(51) Int. Cl. H04L 9/40

(52) U.S. Cl. CPC H04L 63/1441; H04L 63/1416; H04L 63/1425

(57) ABSTRACT

According to one embodiment, a method, computer system, and computer program product for cryptojacking prevention is provided. The embodiment may include capturing a plurality of processor usage information. The embodiment may also include identifying a process or a program using processing power above a preconfigured threshold based on the plurality of captured processor usage information. The embodiment may further include, in response to determining the identified process or the identified program is not approved by a system administrator, performing an action using operating system workload managers based on preconfigured preferences.

### BACKGROUND

The present invention relates generally to the field of computing, and more particularly to cryptojacking prevention.

In the financially decentralized realm of cryptocurrency, records across a blockchain are linked using cryptographic hashes to prevent alteration and require validation in order to prevent fraudulent transactions from being entered into the blockchain. Some individuals permit the processing power of their device(s) to be used for validations of transactions across a blockchain in exchange for payment in the form of cryptocurrency. This process of validation is commonly referred to as cryptomining and can prove lucrative after offsetting the cost of hardware purchases and operation energy charges are accounted for.

Cryptojacking relates to a cybercrime where an individual utilizes the processing power of a computing device, unbeknownst to the owner, to mine for cryptocurrency. Typically, cryptojacking of a computing device occurs when the owner unwittingly installs malicious scripts that allow other individuals to access the computing device and, possibly, other devices within the same network. Cryptojacking may affect system performance, battery life drainage, processor or battery overheating, increased network traffic, and/or component failure due to the constant stress on the affected computing device(s) and network(s) as well as incur increased expenses for the owner due to the greater power consumption.

Due to an increasingly high valuation of cryptocurrencies and the ability to utilize computer processing power for profit, cryptomining is becoming an ever-popular form of monetary generation. However, due to the recency in development for cryptomining software, few viable cryptojacking detection techniques currently exist. Some current cryptojacking monitoring techniques involve a “needle in the haystack” method where network traffic and system and program configurations are monitored to identify anomalies. However, such methods may be fraught with issues in ever increasingly complex information technology environments due to cryptojacking software evolving to avoid many typical detection methods, such as overheating detection and performance impact detection.

### SUMMARY

According to one embodiment, a method, computer system, and computer program product for cryptojacking prevention is provided. The embodiment may include capturing a plurality of processor usage information. The embodiment may also include identifying a process or a program using processing power above a preconfigured threshold based on the plurality of captured processor usage information. The embodiment may further include, in response to determining the identified process or the identified program is not approved by a system administrator, performing an action using operating system workload managers based on preconfigured preferences.

In a preferred embodiment, the method further includes capturing a plurality of usage of a vector processor, determining a processor is to be flagged based on the plurality of captured usage, flagging the process, and determining the flagged process is not approved by a system administrator based on comparison to a list of system administrator-approved processes.

In a preferred embodiment, the method further includes capturing a plurality of process history during device operation, correlating the plurality of captured process history to in-network processes and system I/O usage, and determining the correlation matches a cryptojacking model.

In a preferred embodiment, the method further includes, in response to determining the identified process or the identified program is not approved by a system administrator, transmitting a notification to a system administrator.

In a preferred embodiment, the action is selected from a group consisting of preventing the identified program or the identified process from utilizing the processor and throttling usage of the processor by the identified program or the identified process.

In a preferred embodiment, the preconfigured threshold is a value of processor usage or a value of time.

In a preferred embodiment, determining the identified process or the identified program is not approved by a system administrator further includes comparing identifying information of the identified process or the identified program to a preconfigured approval list, and wherein the identifying information is selected from a group consisting of a program name, a process name, a program file name, a program file extension, a program installation date, a program publisher, a process initiation location, a program type, and a process type.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a usage history cryptojacking identification process according to at least one embodiment.

FIG. 3 illustrates an operational flowchart for a table comparison cryptojacking identification process according to at least one embodiment.

FIG. 4 illustrates an operational flowchart for a pattern correlation cryptojacking identification process according to at least one embodiment.

FIG. 5 is an exemplary block diagram of a hardware-assisted cryptojacking shutdown according to at least one embodiment.

FIG. 6 is a block diagram of internal and external components of computers and servers depicted in FIG. 1 according to at least one embodiment.

FIG. 7 depicts a cloud computing environment according to an embodiment of the present invention.

FIG. 8 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to cryptojacking prevention. The following described exemplary embodiments provide a system, method, and program product to, among other things, identify various indicators that a computing device has been compromised by cryptojacking software and implement one or more corrective measures to correct the unauthorized actions. Therefore, the present embodiment has the capacity to improve the technical field of cryptojacking prevention, and more broadly system security, by increasing system performance, network performance, and component longevity due to the improved cryptojacking identification and amelioration.

As previously described, in the financially decentralized realm of cryptocurrency, records across a blockchain are linked using cryptographic hashes to prevent alteration and require validation in order to prevent fraudulent transactions from being entered into the blockchain. Some individuals permit the processing power of their device(s) to be used for validations of transactions across a blockchain in exchange for payment in the form of cryptocurrency. This process of validation is commonly referred to as cryptomining and can prove lucrative after offsetting the cost of hardware purchases and operation energy charges are accounted for.

Cryptojacking relates to a cybercrime where an individual utilizes the processing power of a computing device, unbeknownst to the owner, to mine for cryptocurrency. Typically, cryptojacking of a computing device occurs when the owner unwittingly installs malicious scripts that allow other individuals to access the computing device and, possibly, other devices within the same network. Cryptojacking may affect system performance, battery life drainage, processor or battery overheating, increased network traffic, and/or component failure due to the constant stress on the affected computing device(s) and network(s) as well as incur increased expenses for the owner due to the greater power consumption.

Due to an increasingly high valuation of cryptocurrencies and the ability to utilize computer processing power for profit, cryptomining is becoming an ever-popular form of monetary generation. However, due to the recency in development for cryptomining detection software, few viable cryptojacking techniques currently exist. Some current cryptojacking monitoring techniques involve a “needle in the haystack” method where network traffic and system and program configurations are monitored to identify anomalies. However, such methods may be fraught with issues in ever increasingly complex information technology environments due to cryptojacking software evolving to avoid many typical detection methods, such as overheating detection and performance impact detection.

Furthermore, developments in the computer hardware space result in computing devices with vastly larger processing power than has previously been capable. For example, computer servers and mainframes present high processing power and high throughput I/O. If an individual with malicious intent were capable of accessing the processing power and high throughput I/O of such a system while maintaining a constant connection to the blockchain then the system may be a prime target for cryptojacking attacks. Many high performance enterprise systems are equipped with a vast array of security measures but vulnerabilities may still exist in the form of insider threats and poor system administration. As such, it may be advantageous to, among other things, develop a cryptojacking prevention program that utilizes various forms of cryptojacking identification and amelioration beyond typical “needle in the haystack” frameworks.

According to at least one embodiment, processing power usage history, process table comparisons, and process history table correlations may effectively identify ongoing cryptojacking attacks to a system. Since many enterprise systems, such as servers and mainframes, are commonly owned and/or developed from the operating system to the hardware, a unique opportunity may exist to prevent cryptojacking. Since cryptojacking typically does a large set of vector operations in order to crunch large sets of numbers quickly and communicate back to the blockchain as to what the next set of calculations are to be computed, the processor(s) of the computing device may increase in speed and, at times, become fully utilized. The utilization may provide indications of cryptojacking if analyzed appropriately. Analyzing usage can be difficult as many different processes may be running on the system that utilize vector processing and are not related to cryptojacking or any other malicious operation. Therefore, processor usage history may be recorded over a preconfigured period of time to determine which processes are using preconfigured amounts of processing power in the vector processing unit. If a process or program is continually using a very large amount of processing power through the vector processing unit, the process or program may be flagged for verification by an administrator due to possible signs of cryptojacking.

In another embodiment, processing power usage history may be paired with process table comparisons to detect cryptojacking operations due to some cryptojacking software being developed to avoid overextending processing power. In such situations, the cryptojacking software may suspend, or sleep, and use less CPU power in order to go undetected in complex environments. To detect software with such capabilities, process table records may be utilized to compare the current process with historical usage of the vector processor along with time stamps as a higher level gauge of usage.

In yet another embodiment, correlation of the process history table may be utilized in addition to either or both of processing power usage history and process table comparisons. Due to some cryptojacking software being programmed for both low utilization and being installed to the device as a result of an insider threat, more advanced techniques may be needed to flag the offending program. Correlation of the process history table along with the processes network/system I/O usage may result in a satisfactory solution. If the two match well known patterns based on known cryptojacking models, then the process/program may be flagged to the system administrator.

One or more embodiments described above may convey the advantage of cryptojacking detection faster and more accurately than by traditional security solutions as the detection can occur on a single system within seconds of high utilization, unauthorized use, or suspicious network traffic pairing.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

The following described exemplary embodiments provide a system, method, and program product to identify and ameliorate cryptojacking attacks on a computing device through various identification measures.

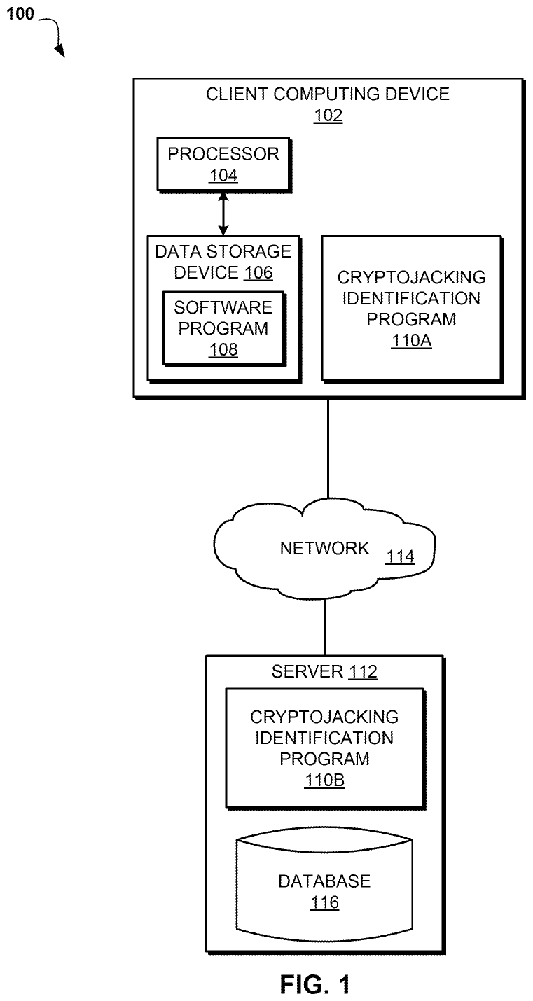

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity. Additionally, in one or more embodiments, the client computing device 102 and server 112 may each individually host a cryptojacking identification program 110A, 110B. In one or more other embodiments, the cryptojacking identification program 110A, 110B may be partially hosted on both the client computing device 102 and the server 112 so that functionality may be separated between the devices.

The communication network 114 may include various types of communication networks, such as a wide area network (WAN), local area network (LAN), a telecommunication network, a wireless network, a wireless ad hoc network (i.e., a wireless mesh network), a public switched network, a radio frequency (RF) network, and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

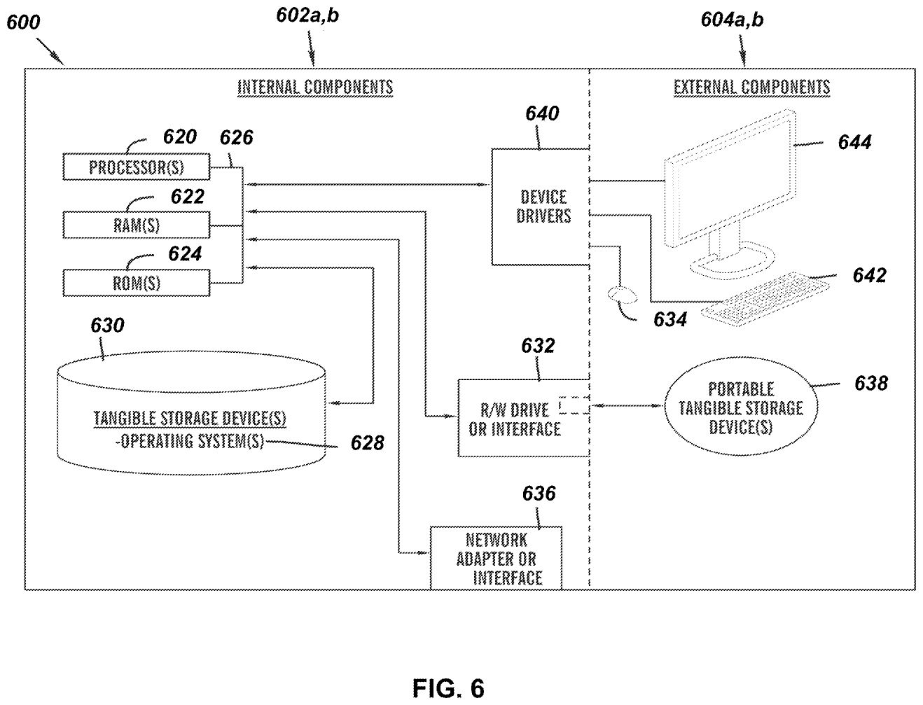

Client computing device 102 may include a processor 104 and a data storage device 106 that is enabled to host and run a software program 108 and the cryptojacking identification program 110A and communicate with the server 112 via the communication network 114, in accordance with one embodiment of the invention. In one or more other embodiments, client computing device 102 may be, for example, a mobile device, a smartphone, a personal digital assistant, a netbook, a laptop computer, a tablet computer, a desktop computer, or any type of computing device capable of running a program and accessing a network. As previously described, one client computing device 102 is depicted in FIG. 1 for illustrative purposes, however, any number of client computing devices 102 may be utilized. As will be discussed with reference to FIG. 6, the client computing device 102 may include internal components 602a and external components 604a, respectively.

The server computer 112 may be a laptop computer, netbook computer, personal computer (PC), a desktop computer, or any programmable electronic device or any network of programmable electronic devices capable of hosting and running the cryptojacking identification program 110B and a database 116 and communicating with the client computing device 102 via the communication network 114, in accordance with embodiments of the invention. As will be discussed with reference to FIG. 6, the server computer 112 may include internal components 602b and external components 604b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

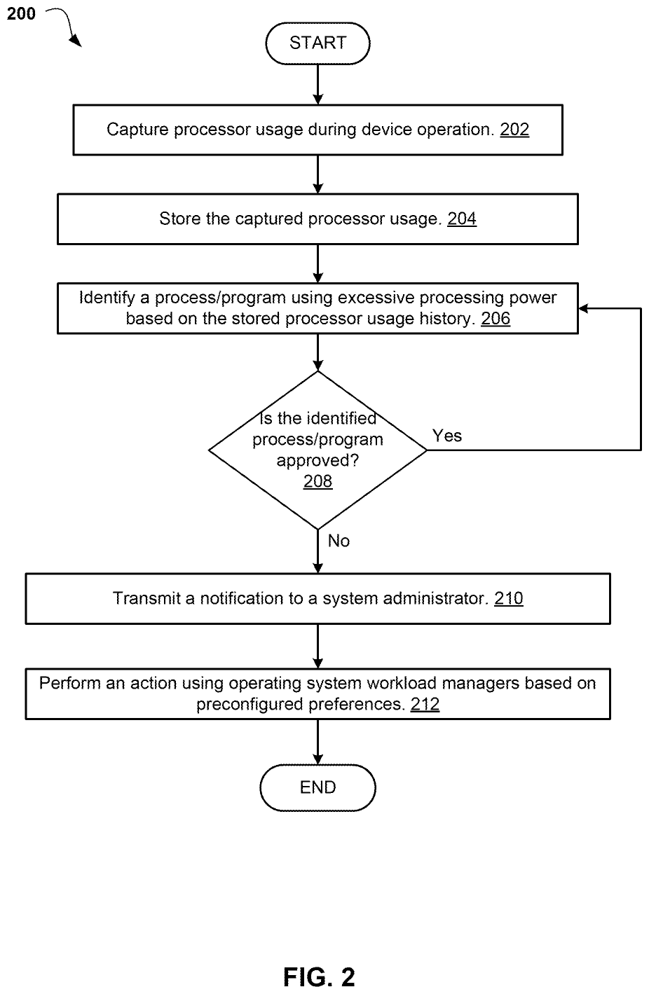

According to the present embodiment, the cryptojacking identification program 110A, 110B may be capable of identifying cryptojacking software installed in a computing device, such as client computing device 102 or server 112, based on an analysis of captured system usage information against a variety of metrics. In one or more embodiments, cryptojacking identification program 110A, 110B may utilize usage history of a vector processing unit from the captured usage history recorded over a period of time for identification of an anomalous spike in processing power through the vector processing unit. In one or more other embodiments, the cryptojacking identification program 110A, 110B may be capable of identifying cryptojacking software that is configured to suspend operations, or sleep, and use less CPU power to go undetected during complex operations by compares system processes against a process table that records the usage of the vector processor along with time stamps as a higher-level gauge of usage. In yet another embodiment, the cryptojacking identification program 110A, 110B may be able to identify cryptojacking installed through an insider threat by correlating the process history table of the computing device to the processes network/system I/O usage for matches to well-known patterns associated with cryptojacking models. The cryptojacking identification method is explained in further detail below with respect to FIGS. 2-4.

Referring now to FIG. 2, an operational flowchart for a usage history cryptojacking identification process 200 is depicted according to at least one embodiment. At 202, the cryptojacking identification program 110A, 110B captures processor usage information during device operation. In order to identify possible cryptojacking of a computing device, the cryptojacking identification program 110A, 110B may capture processor usage information during normal device operation to understand which processes are using the processing power of the vector processing unit during a specific period of time. Since a program or process that is utilizing a large amount of processing power through the vector processing unit may be an indication of a cryptojacking attack, the processor usage information may include a name of each program using a preconfigured threshold amount of processing power during a preconfigured time period, the total amount of processing power used, and the amount of time the utilized processing power remained above the preconfigured threshold. Each preconfigured threshold observed and utilized by the cryptojacking identification program 110A, 110B may be established by a system administrator during initial set up of the cryptojacking identification program 110A, 110B or manually configured during operation. In at least one embodiment, the thresholds may be variable values depending on various circumstances, such as time of day. For example, the threshold amount of processing power to trigger the capturing of processing power information may be lower during an early morning period (e.g., 3:00 A.M. to 4:00 A.M.) since a computing device may be idle during that time period.

Then, at 204, the cryptojacking identification program 110A, 110B stores the captured processor usage information. Upon capturing the processor usage information of the vector processing unit, the cryptojacking identification program 110A, 110B may store the captured information in a repository, such as database 116, for further analysis of anomalies or excessive power usage by processes or programs within the computing device.

Next, at 206, the cryptojacking identification program 110A, 110B identifies a process or program using excessive processing power based on the stored process usage history. The cryptojacking identification program 110A, 110B may identify a process or program as using excessive processing power through a comparison of the stored processor usage information against a preconfigured threshold value of processor usage. For example, if a threshold value of processing power is preconfigured by a system administrator at x units and a specific program, such as software program 108, has a stored processing power usage of the vector processing unit for a specific period of time as x+3 units, the cryptojacking identification program 110A, 110B may identify the program as using excessive processing power. In at least one embodiment, the preconfigured threshold of processing power usage may be unique to specific programs/processes or for program/process types.

In at least one other embodiment, the cryptojacking identification program 110A, 110B may utilize a threshold value of time for which a program or process must use processing power of the vector processing unit above the threshold value. For example, if the time threshold value is preconfigured to five minutes, the cryptojacking identification program 110A, 110B may only identify a process or program that uses the processing power of the vector processing unit above the usage threshold value for greater than five minutes. If a program of process uses the processing power of the vector processing unit above the usage threshold value but for less than five minutes, the cryptojacking identification program 110A, 110B may not identify the program or process since the time threshold value is not satisfied.

In at least one embodiment, the cryptojacking identification program 110A, 110B may identify some processes or programs that consume consistent amounts of processing power over a preconfigured period of time even if such processes do not exceed the preconfigured threshold value of processing power. For example, a cryptojacking program may be developed to use less than the preconfigured threshold of processing power so as to remain undetected by the cryptojacking identification program 110A, 110B. However, the cryptojacking program may consume an extremely consistent amount of processing power, which the cryptojacking identification program 110A, 110B may identify as anomalous and flag the program for further review as discussed below.

Then, at 208, the cryptojacking identification program 110A, 110B determines whether the identified process or program is approved. Once a program or process has been identified as using excessive processing power of the vector processing unit, the cryptojacking identification program 110A, 110B may then determine whether the process or program is approved for operating on the computing device. The cryptojacking identification program 110A, 110B may determine whether a program or process is approved by comparison of identifying information (e.g., program/process name, program file name, program file extension, program installation date, program publisher, process initiation location, program type, process type, etc.) of the program or process to a preconfigured approval list. The preconfigured approval list may be a list of programs or processes approved for operation by the owner or a system administrator of the computing device. For example, processes or programs configured as start-up programs and processes with known publishers and installation dates long in the past may appear on the preconfigured approval list. However, a program with an unknown publisher and a recent installation date with a large amount of outbound transmissions across a network, such as network 114, may not appear on the preconfigured approval list. If the cryptojacking identification program 110A, 110B determines the identified program or process is not approved (step 208, “No” branch), then the usage history cryptojacking identification process 200 may proceed to step 210 to transmit a notification to a system administrator. If the cryptojacking identification program 110A, 110B determines the identified program or process is approved (step 208, “Yes” branch), then the usage history cryptojacking identification process 200 may return to step 206 to identify a process or program using excessive processing power based on the stored processor usage history.

Next, at 210, the cryptojacking identification program 110A, 110B transmits a notification to a system administrator. If the cryptojacking identification program 110A, 110B determines that a program or process is not approved to be present and/or operating on the computing device, the cryptojacking identification program 110A, 110B may transmit a notification to a system administrator or a user. The notification may be in the form of an operating system notification, an email, a text message, an SMS message, an instant message, a notification to a preconfigured program (e.g., software program 108), or any other electronic message available for display to a system administrator or user on a display screen graphical user interface. For example, if the cryptojacking identification program 110A, 110B identifies a specific program or process as not being approved, the cryptojacking identification program 110A, 110B may transmit an email to a system administrator indicating the high processing power usage of the identified program or process as well as detailed information relating to the program or process, such as name and installation location for programs and name and issuing program/location for a process. The identifying information in the previous example is merely exemplary and any degree and type of identifying information accessible by the cryptojacking identification program 110A, 110B may be provided in the notification to the system administrator or user.

Then, at 212, the cryptojacking identification program 110A, 110B performs an action using operating system workload managers based on preconfigured preferences. In at least one embodiment, the cryptojacking identification program 110A, 110B may receive confirmation from the notified system administrator that a program or process for which the system administrator was notified should be flagged. When a program or process is flagged and preconfigurations dictate, the cryptojacking identification program 110A, 110B may prevent the process or program from utilizing the processing unit until the flag is removed. Furthermore, in the event the flag was placed on a process, the cryptojacking identification program 110A, 110B may attempt to identify the program from which the process originated and, upon identifying the program or if the flag was placed on a known program, attempt to remove, or flag for removal by a system administrator, the program from the computing device. In at least one embodiment, since the operating system and hardware may be interlocked in this identification and a system administrator may be needed to perform a manual uninstall, the cryptojacking identification program 110A, 110B may throttle or contain the identified cryptojacking program using operating system workload managers until an alert is addressed by a system administrator.

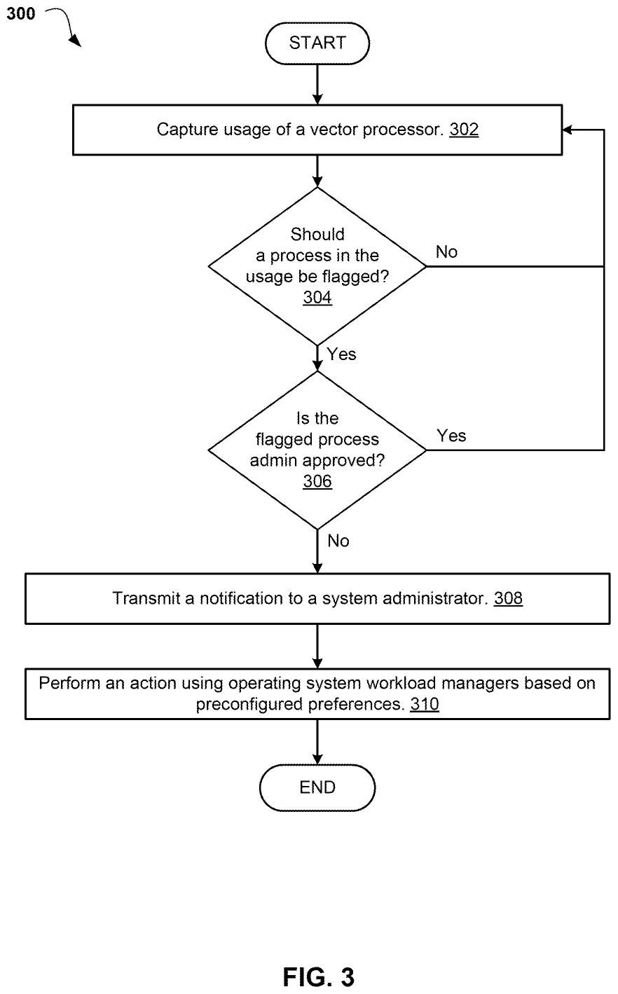

Referring now to FIG. 3, an operational flowchart for a table comparison cryptojacking identification process 300 is depicted according to at least one embodiment. Some cryptojacking software may be developed to avoid detection through the monitoring of processing power. As such, some cryptojacking software is programmed to suspend operation, or sleep, and/or use less CPU power in order to remain undetected in complex environments. Therefore, the cryptojacking identification program 110A, 110B may utilize the table comparison cryptojacking identification process 300 to identify such detection avoidance methods. Identifying cryptojacking through recordation of vector processor usage may not be as quick of a process as monitoring expended processing power as described in FIG. 2. However, analysis of vector process usage may be a higher level gauge that can determine a general usage of the operating system over time while allowing for a fast lookup of usage throughout the computing device.

At 302, the cryptojacking identification program 110A, 110B captures usage information of a vector processor. Similar to step 202 where the cryptojacking identification program 110A, 110B captures processor usage information during device operation, the cryptojacking identification program 110A, 110B may capture usage information of the vector processor during normal operation. The cryptojacking identification program 110A, 110B may capture the usage information of the vector processor as a process table of the vector process usage history with accompanying time stamps as a high level gauge of usage of the vector processor.

Then, at 304, the cryptojacking identification program 110A, 110B determines whether a process in the captured usage information should be flagged. As previously described, the process table may identify common or routine processes performed by the computing device as detailed in the captured usage information. A deviation in processor usage amount or time of execution from the common or routine processes or a new process may signal that a process should be flagged for review. The cryptojacking identification program 110A, 110B may determine that a process should be flagged if a process is executing with higher than a threshold amount of usage, is executing at a time of day at which it does not normally execute, or if the process has never been executed previously from an unknown or untrusted program. If the cryptojacking identification program 110A, 110B determines the process should be flagged (step 304, “Yes” branch), then the table comparison cryptojacking identification process 300 may proceed to step 306 to determine if the flagged process is approved by a system administrator. If the cryptojacking identification program 110A, 110B determines the process should not be flagged (step 304, “No” branch), then the table comparison cryptojacking identification process 300 may return to step 302 to capture usage of the vector processor.

Next, at 306, the cryptojacking identification program 110A, 110B determines whether the flagged process has system administrator approval. The cryptojacking identification program 110A, 110B may determine that a flagged process is system administrator-approved based on a comparison of each flagged process against a table of system administrator-approved processes. If the cryptojacking identification program 110A, 110B determines the flagged process is not approved by a system administrator (step 306, “No” branch), then the table comparison cryptojacking identification process 300 may proceed to step 308 to transmit a notification to the system administrator. If the cryptojacking identification program 110A, 110B determines the flagged process is approved by a system administrator (step 306, “Yes” branch), cryptojacking identification program 110A, 110B may remove the flag from the process and allow the process to continue operation then the table comparison cryptojacking identification process 300 may return to step 302 to capture usage of the vector processor.

Then, at 308, the cryptojacking identification program 110A, 110B transmits a notification to a system administrator. Similar to step 210, if the cryptojacking identification program 110A, 110B determines a process does not have previous system administrator approval, the cryptojacking identification program 110A, 110B may transmit a notification to the system administrator with details relating to the flagged program or process. As previously discussed, the notification may be in the form of an operating system notification, an email, a text message, an SMS message, an instant message, a notification to a preconfigured program (e.g., software program 108), or any other electronic message available for display to a system administrator or user on a display screen graphical user interface.

Next, at 310, the cryptojacking identification program 110A, 110B performs an action using operating system workload managers based on preconfigured preferences. Similar to step 212, the cryptojacking identification program 110A, 110B may perform an action consistent with system administrator direction in response to the transmitted notification or system preconfigurations. In at least one embodiment, the cryptojacking identification program 110A, 110B may receive confirmation from the notified system administrator that a program or process for which the system administrator was notified should be flagged. When a program or process is flagged and preconfigurations dictate, the cryptojacking identification program 110A, 110B may prevent the process or program from utilizing the processing unit until the flag is removed. Furthermore, in the event the flag was placed on a process, the cryptojacking identification program 110A, 110B may attempt to identify the program from which the process originated and, upon identifying the program or if the flag was placed on a known program, attempt to remove, or flag for removal by a system administrator, the program from the computing device. In at least one embodiment, since the operating system and hardware may be interlocked in this identification and a system administrator may be needed to perform a manual uninstall, the cryptojacking identification program 110A, 110B may throttle or contain the identified cryptojacking program using operating system workload managers until an alert is addressed by a system administrator.

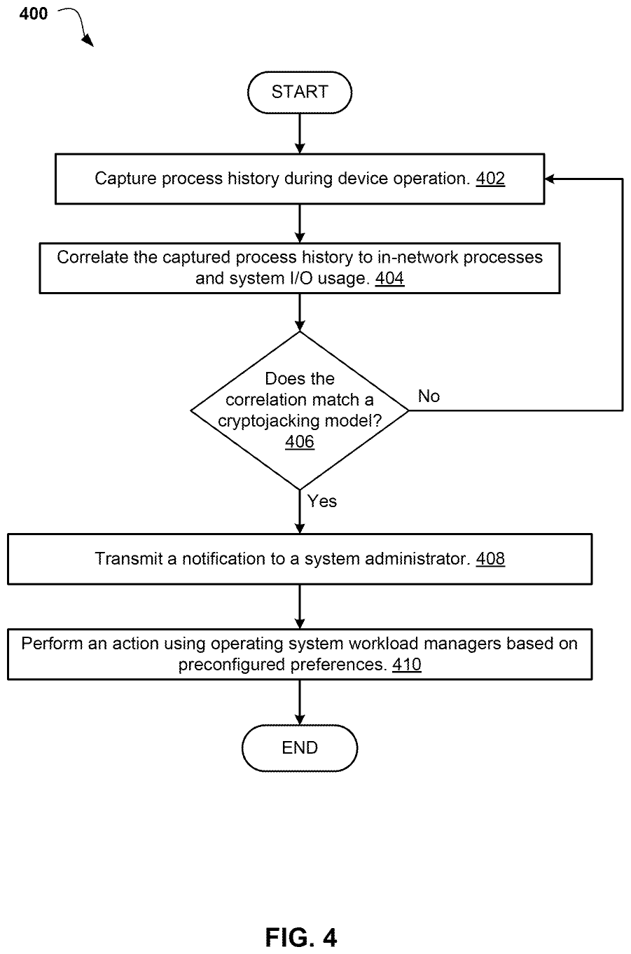

Referring now to FIG. 4, an operational flowchart for a pattern correlation cryptojacking identification process 400 is depicted according to at least one embodiment. Some other cryptojacking software may be programmed for both low processor utilization as well as being installed due to an insider threat. An insider threat may relate to an attack originating within an organization. Common sources of insider threats include, but are not limited to, current employees or organization affiliates, that may have access to assets, such as client computing device 102 or server 112, and may be capable of installing a program, such as a cryptojacking program, on the asset. As a result of the capabilities of low processor utilization cryptojacking software that has been installed through an insider threat, the cryptojacking identification program 110A, 110B may require more advanced techniques to identify the presence of cryptojacking software, such as correlating known models of cryptojacking processes to processor behaviors exhibited by a computing device.

At 402, the cryptojacking identification program 110A, 110B captures process history during device operation. Similar to steps 202 and 302, the cryptojacking identification program 110A, 110B may capture process usage information while a computing device is operating. The captured usage information may then be used to generate a process history table in order to understand the processes run on the computing device during a specific period of time.

Then, at 404, the cryptojacking identification program 110A, 110B correlates the captured process history to in-network processes and system I/O usage. Once the process history table is available, the cryptojacking identification program 110A, 110B may correlate the process history table with in-network processes and system I/O usage. The correlation may be useful for understanding patterns exhibited by the computing device.

Next, at 406, the cryptojacking identification program 110A, 110B determines whether the correlation matches a cryptojacking model. Once the cryptojacking identification program 110A, 110B has correlated the process history to the in-network processes and system I/O usage, the cryptojacking identification program 110A, 110B may determine whether the correlation matches a cryptojacking model. The cryptojacking identification program 110A, 110B may be receive models of known or common cryptojacking programs through a repository, such as database 116. In at least one embodiment, the repository may be a third-party database, such as a community forum or IT ecosystem, that shares such models for cryptojacking identification.

Once obtained, the cryptojacking identification program 110A, 110B may be capable of comparing and analyzing the correlation of the process history table with the in-network processes and system I/O usage to any cryptojacking model. The cryptojacking identification program 110A, 110B may determine a match exists when the correlation shares a preconfigured threshold number of process matches to a cryptojacking model. If the cryptojacking identification program 110A, 110B determines the correlation matches a cryptojacking model (step 406, “Yes” branch), then the pattern correlation cryptojacking identification process 400 may proceed to step 408 to transmit a notification to the system administrator. If the cryptojacking identification program 110A, 110B determines the correlation does not match a cryptojacking process (step 406, “No” branch), pattern correlation cryptojacking identification process 400 may return to step 402 to capture process history during device operation.

Then, at 408, the cryptojacking identification program 110A, 110B transmits the notification to a system administrator. Similar to steps 210 and 308, if the cryptojacking identification program 110A, 110B determines the correlation matches a cryptojacking model, the cryptojacking identification program 110A, 110B may transmit a notification to the system administrator with details relating to the program or process. As previously discussed, the notification may be in the form of an operating system notification, an email, a text message, an SMS message, an instant message, a notification to a preconfigured program (e.g., software program 108), or any other electronic message available for display to a system administrator or user on a display screen graphical user interface.

Next, at 410, the cryptojacking identification program 110A, 110B performs an action using operating system workload managers based on preconfigured preferences. Similar to steps 212 and 310, the cryptojacking identification program 110A, 110B may perform an action consistent with system administrator direction in response to the transmitted notification or system preconfigurations. In at least one embodiment, the cryptojacking identification program 110A, 110B may receive confirmation from the notified system administrator that a program or process for which the system administrator was notified should be flagged. When a program or process is flagged and preconfigurations dictate, the cryptojacking identification program 110A, 110B may prevent the process or program from utilizing the processing unit until the flag is removed. Furthermore, in the event the flag was placed on a process, the cryptojacking identification program 110A, 110B may attempt to identify the program from which the process originated and, upon identifying the program or if the flag was placed on a known program, attempt to remove, or flag for removal by a system administrator, the program from the computing device. In at least one embodiment, since the operating system and hardware may be interlocked in this identification and a system administrator may be needed to perform a manual uninstall, the cryptojacking identification program 110A, 110B may throttle or contain the identified cryptojacking program using operating system workload managers until an alert is addressed by a system administrator.

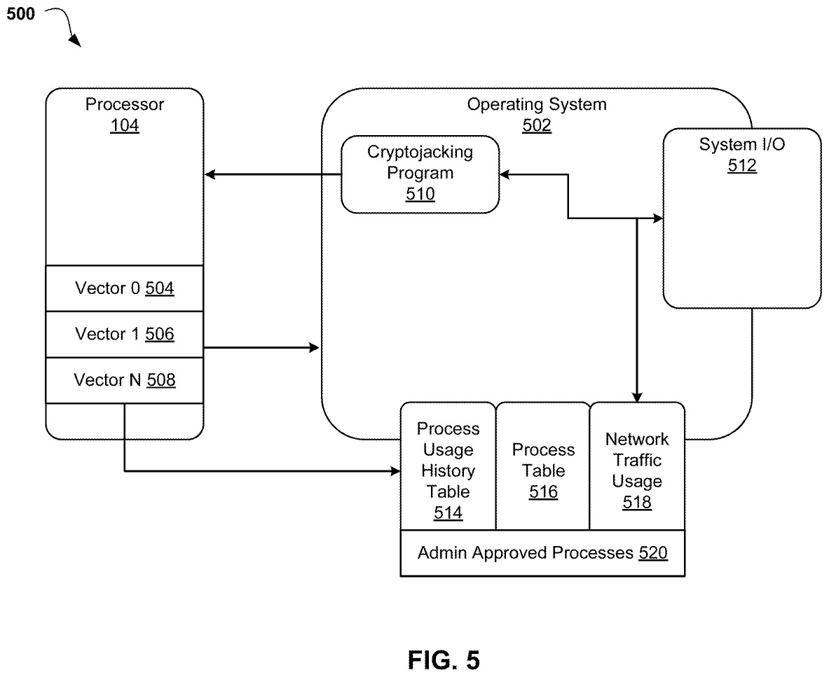

Referring now to FIG. 5, an exemplary block diagram of a hardware-assisted cryptojacking shutdown 500 according to at least one embodiment. The hardware-assisted cryptojacking shutdown 500 may depict internal components, such as processor 104 and operating system 502, of a computing device, such as client computing device 102. The hardware-assisted shutdown 500 may depict operations of the cryptojacking identification program 110A, 110B through the usage history cryptojacking identification process 200, the table comparison cryptojacking identification process 300, and the pattern correlation cryptojacking identification process 400. During operation, a cryptojacking program 510 may issues many vector processing commands, such as vector 0 504, vector 1 506, and vector N 508, in the vector processing pipeline through the processor 104. Vector processing usage may be recorded in a repository, such as database 116, as the process usage history table 514. Additionally, the used network traffic from the cryptojacking program 510 to the system I/O 512 may be recorded in the network traffic usage 518. The cryptojacking identification program 110A, 110B, through the usage history cryptojacking identification process 200, the table comparison cryptojacking identification process 300, and the pattern correlation cryptojacking identification process 400, may check the process usage history table 514, the process table 516, and the network traffic usage 518 to determine if anomalous behavior, processes, and/or programs are being experienced. Any anomaly identified by the cryptojacking identification program 110A, 110B may be compared against admin approved processes 520, which may also be stored in a repository (e.g., database 116), to determine if an identified behavior, process, or program is approved by a system administrator. If a behavior, process, or program is not approved in the repository of admin approved processes 520, a notification may be transmitted to a system administrator and possible throttling or termination of processing the commands through the processor 104.

It may be appreciated that FIGS. 2-5 provide only an illustration of one implementation and do not imply any limitations with regard to how different embodiments may be implemented. Many modifications to the depicted environments may be made based on design and implementation requirements.

FIG. 6 is a block diagram 600 of internal and external components of the client computing device 102 and the server 112 depicted in FIG. 1 in accordance with an embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

The data processing system 602, 604 is representative of any electronic device capable of executing machine-readable program instructions. The data processing system 602, 604 may be representative of a smart phone, a computer system, PDA, or other electronic devices. Examples of computing systems, environments, and/or configurations that may represented by the data processing system 602, 604 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 602 a,b and external components 604 a,b illustrated in FIG. 6. Each of the sets of internal components 602 include one or more processors 620, one or more computer-readable RAMs 622, and one or more computer-readable ROMs 624 on one or more buses 626, and one or more operating systems 628 and one or more computer-readable tangible storage devices 630. The one or more operating systems 628, the software program 108 and the cryptojacking identification program 110A in the client computing device 102 and the cryptojacking identification program 110B in the server 112 are stored on one or more of the respective computer-readable tangible storage devices 630 for execution by one or more of the respective processors 620 via one or more of the respective RAMs 622 (which typically include cache memory). In the embodiment illustrated in FIG. 6, each of the computer-readable tangible storage devices 630 is a magnetic disk storage device of an internal hard drive. Alternatively, each of the computer-readable tangible storage devices 630 is a semiconductor storage device such as ROM 624, EPROM, flash memory or any other computer-readable tangible storage device that can store a computer program and digital information.

Each set of internal components 602 a,b also includes a RAY drive or interface 632 to read from and write to one or more portable computer-readable tangible storage devices 638 such as a CD-ROM, DVD, memory stick, magnetic tape, magnetic disk, optical disk or semiconductor storage device. A software program, such as the cryptojacking identification program 110A, 110B, can be stored on one or more of the respective portable computer-readable tangible storage devices 638, read via the respective RAY drive or interface 632, and loaded into the respective hard drive 630.

Each set of internal components 602 a,b also includes network adapters or interfaces 636 such as a TCP/IP adapter cards, wireless Wi-Fi interface cards, or 3G, 4G, or 5G wireless interface cards or other wired or wireless communication links. The software program 108 and the cryptojacking identification program 110A in the client computing device 102 and the cryptojacking identification program 110B in the server 112 can be downloaded to the client computing device 102 and the server 112 from an external computer via a network (for example, the Internet, a local area network or other, wide area network) and respective network adapters or interfaces 636. From the network adapters or interfaces 636, the software program 108 and the cryptojacking identification program 110A in the client computing device 102 and the cryptojacking identification program 110B in the server 112 are loaded into the respective hard drive 630. The network may comprise copper wires, optical fibers, wireless transmission, routers, firewalls, switches, gateway computers and/or edge servers.

Each of the sets of external components 604 a,b can include a computer display monitor 644, a keyboard 642, and a computer mouse 634. External components 604 a,b can also include touch screens, virtual keyboards, touch pads, pointing devices, and other human interface devices. Each of the sets of internal components 602 a,b also includes device drivers 640 to interface to computer display monitor 644, keyboard 642, and computer mouse 634. The device drivers 640, R/W drive or interface 632, and network adapter or interface 636 comprise hardware and software (stored in storage device 630 and/or ROM 624).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

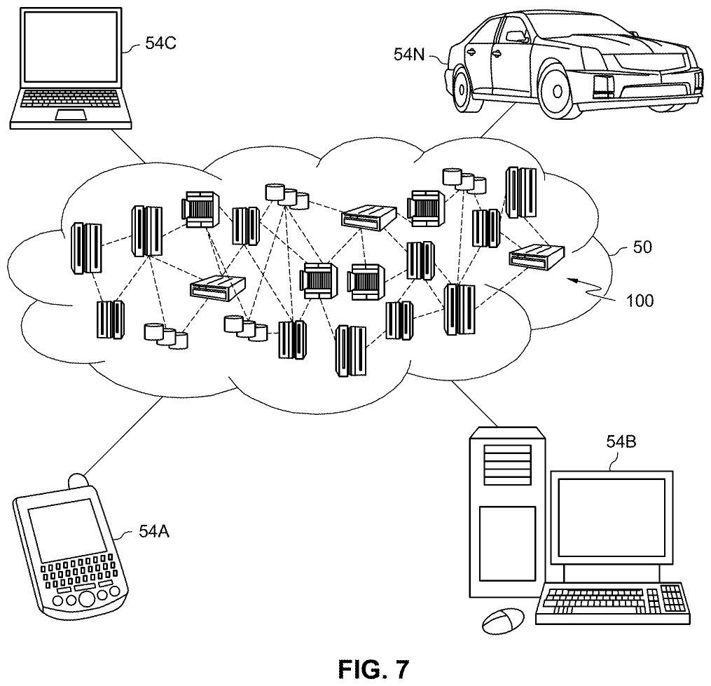

Referring now to FIG. 7, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 100 and cloud computing environment 50 can communicate with any type of computerized device over any type of network and/or network addressable connection (e.g., using a web browser).

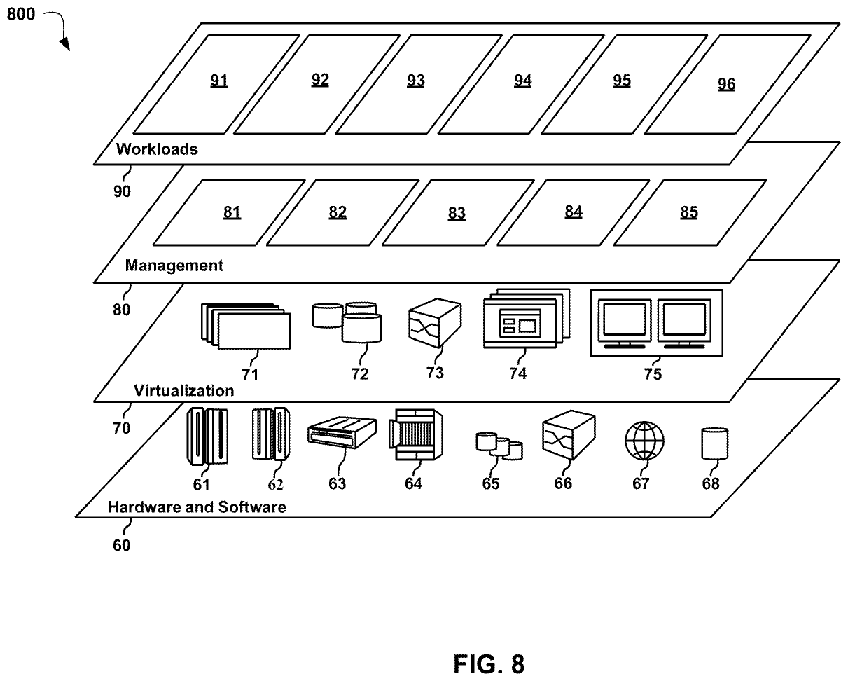

Referring now to FIG. 8, a set of functional abstraction layers 800 provided by cloud computing environment 50 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cryptojacking identification 96. Cryptojacking identification 96 may relate to capturing various items of processor usage information to detect anomalies in processor usage (e.g., usually high usage, uncommon processes, and/or processes matching known cryptojacking models) and ameliorate any detected cryptojacking threats.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
capturing, by a processor, a plurality of processor usage information;
identifying a process or a program using processing power above a preconfigured threshold based on the plurality of captured processor usage information; and
in response to determining the identified process or the identified program is not approved by a system administrator, performing an action using operating system workload managers based on preconfigured preferences.

2. The method of claim 1, further comprising:
capturing a plurality of usage of a vector processor;
determining a process is to be flagged based on the plurality of captured usage;
flagging the process; and
determining the flagged process is not approved by the system administrator based on comparison to a list of system administrator-approved processes.

3. The method of claim 1, further comprising:
capturing a plurality of process history during device operation;
correlating the plurality of captured process history to in-network processes and system I/O usage; and
determining the correlation matches a cryptojacking model.

4. The method of claim 1, further comprising:
in response to determining the identified process or the identified program is not approved by a system administrator, transmitting a notification to a system administrator.

5. The method of claim 1, wherein the action is selected from a group consisting of preventing the identified program or the identified process from utilizing the processor and throttling usage of the processor by the identified program or the identified process.

6. The method of claim 1, wherein the preconfigured threshold is a value of processor usage or a value of time.

7. The method of claim 1, wherein determining the identified process or the identified program is not approved by a system administrator further comprises:
comparing identifying information of the identified process or the identified program to a preconfigured approval list, and wherein the identifying information is selected from a group consisting of a program name, a process name, a program file name, a program file extension, a program installation date, a program publisher, a process initiation location, a program type, and a process type.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
capturing, by a processor, a plurality of processor usage information;
identifying a process or a program using processing power above a preconfigured threshold based on the plurality of captured processor usage information; and
in response to determining the identified process or the identified program is not approved by a system administrator, performing an action using operating system workload managers based on preconfigured preferences.

9. The computer system of claim 8, further comprising:
capturing a plurality of usage of a vector processor;
determining a process is to be flagged based on the plurality of captured usage;
flagging the process; and
determining the flagged process is not approved by the system administrator based on comparison to a list of system administrator-approved processes.

10. The computer system of claim 8, further comprising:
capturing a plurality of process history during device operation;
correlating the plurality of captured process history to in-network processes and system I/O usage; and
determining the correlation matches a cryptojacking model.

11. The computer system of claim 8, further comprising:
in response to determining the identified process or the identified program is not approved by a system administrator, transmitting a notification to a system administrator.

12. The computer system of claim 8, wherein the action is selected from a group consisting of preventing the identified program or the identified process from utilizing the processor and throttling usage of the processor by the identified program or the identified process.

13. The computer system of claim 8, wherein the preconfigured threshold is a value of processor usage or a value of time.

14. The computer system of claim 8, wherein determining the identified process or the identified program is not approved by a system administrator further comprises:
comparing identifying information of the identified process or the identified program to a preconfigured approval list, and wherein the identifying information is selected from a group consisting of a program name, a process name, a program file name, a program file extension, a program installation date, a program publisher, a process initiation location, a program type, and a process type.

15. A computer program product, the computer program product comprising:
one or more computer-readable tangible storage medium and program instructions stored on at least one of the one or more tangible storage medium, the program instructions executable by a processor capable of performing a method, the method comprising:
capturing, by a processor, a plurality of processor usage information;
identifying a process or a program using processing power above a preconfigured threshold based on the plurality of captured processor usage information; and
in response to determining the identified process or the identified program is not approved by a system administrator, performing an action using operating system workload managers based on preconfigured preferences.

16. The computer program product of claim 15, further comprising:
capturing a plurality of usage of a vector processor;
determining a process is to be flagged based on the plurality of captured usage;
flagging the process; and
determining the flagged process is not approved by the system administrator based on comparison to a list of system administrator-approved processes.

17. The computer program product of claim 15, further comprising:
capturing a plurality of process history during device operation;
correlating the plurality of captured process history to in-network processes and system I/O usage; and
determining the correlation matches a cryptojacking model.

18. The computer program product of claim 15, further comprising:
in response to determining the identified process or the identified program is not approved by a system administrator, transmitting a notification to a system administrator.

19. The computer program product of claim 15, wherein the action is selected from a group consisting of preventing the identified program or the identified process from utilizing the processor and throttling usage of the processor by the identified program or the identified process.

20. The computer program product of claim 15, wherein the preconfigured threshold is a value of processor usage or a value of time.
